(19) United States
(12) Patent Application Publication
(10) Pub. No.: US 2026/0178390 A1
(43) Pub. Date: Jun. 25, 2026

(54) DISTRIBUTED WORKER FOR ORCHESTRATION AND MANAGEMENT OF HETEROGENEOUS COMPUTING RESOURCES

(71) Applicant: Hewlett Packard Enterprise Development LP, Spring, TX (US)

(72) Inventors: David Rabon Estes, Westfield, IN (US); Brian David Wheeler, Cherry Hills Village, CO (US)

(21) Appl. No.: 18/990,528

(22) Filed: Dec. 20, 2024

(51) Int. Cl. G06F 9/50

(52) U.S. Cl. CPC G06F 9/5027

(57) ABSTRACT

Systems and methods for managing communications between provider-specific computing resources and a central management platform are provided. A persistent connection is established between a management worker and the central management platform, which may be deployed in a first network. The management worker receives connection requests from agents of provider-specific computing resources, which may be deployed in a second network. A multiplexed message stream is established using the persistent connection in response to the connection requests. The management worker relays messages between the agents and the central management platform through the multiplexed message stream, enabling efficient communication across different networks.

### BACKGROUND

Cloud computing has revolutionized the way organizations manage and deploy IT resources. By providing on-demand access to a shared pool of configurable computing resources, cloud platforms enable organizations to rapidly scale their infrastructure and services without needing large upfront investments in hardware. These resources can include virtual machines, storage, networking, databases, and various software applications and services.

The cloud computing model typically encompasses several service categories, including Infrastructure as a Service (IaaS), Platform as a Service (PaaS), and Software as a Service (SaaS). IaaS provides virtualized computing resources over the internet, allowing users to rent virtual machines, storage, and networking. PaaS offers a platform for developers to build, run, and manage applications without the complexity of maintaining the underlying infrastructure. SaaS delivers software applications over the internet, eliminating users needing to install and run the applications on their computers or infrastructure.

As cloud adoption has grown, many organizations have embraced hybrid and multi-cloud strategies. Hybrid cloud environments combine public and private cloud resources, allowing businesses to keep sensitive data on-premises while leveraging the scalability and cost-effectiveness of public clouds for other workloads. Multi-cloud approaches involve using services from multiple cloud providers, which can help avoid vendor lock-in and optimize for specific capabilities offered by different platforms.

The management and orchestration of resources across diverse cloud environments can present significant challenges for organizations. Various tools and platforms have emerged to address these challenges. However, the rapidly evolving nature of cloud services and the increasing complexity of enterprise IT landscapes continue to present ongoing challenges in this domain.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a cloud computing management environment, according to some implementations.

FIG. 2 is a block diagram of hardware components of the management platform, according to some implementations.

FIG. 3 is a block diagram of the software architecture of the management environment, according to some implementations.

FIG. 4 is a block diagram of a management method, according to some implementations.

FIGS. 5A-5B are block diagrams of a cloud computing management environment, according to some implementations.

FIG. 6 is a flowchart of a worker processing method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Modern enterprise IT environments often encompass heterogeneous computing resources spanning multiple cloud providers, on-premises infrastructure, and various software-as-a-service offerings. Managing and orchestrating these diverse resources may present challenges for organizations.

This disclosure describes a computer system for managing and orchestrating heterogeneous computing resources across diverse cloud environments using a distributed worker architecture. The distributed worker architecture utilizes a management worker in a provider that acts as an intermediary between a central management platform and the various computing resources of that provider.

The management worker establishes a persistent network connection with the central management platform. In some aspects, this connection may be implemented using an outbound secure web socket from the management worker, which may enable communication with resources located behind firewalls or in network configurations that restrict inbound access. The management worker can receive connection requests from multiple agents associated with provider-specific computing resources (such as virtual machines, containers, physical servers, or other workloads) that may be deployed in a provider (such as a public cloud, private cloud, or on-premises infrastructure).

The management worker may establish a multiplexed message stream over the persistent connection to efficiently aggregate and relay messages between the agents and the central management platform. By aggregating communications from multiple agents running on individual resources within a provider, the management worker may potentially reduce the number of connections to the central platform from the provider, which may help in reducing network overhead. In some implementations, this multiplexed message stream approach may allow the management worker to handle communications from many agents through a single network connection to the central platform.

The distributed worker architecture allows for streamlined management of resources across different cloud environments and on-premises infrastructure of an organization. The management worker can forward request messages from the central platform to the appropriate agents and relay their responses back to the central platform, through a single connection to the central platform. This approach may reduce network traffic and improve system performance, especially in scenarios involving geographically distributed resources.

Certain functionality of the central platform can be delegated to the management worker. The management worker may operate locally in a provider's infrastructure to communicate with resources there, and then relay information to the central platform. This may allow some processing and network activity to be moved to the provider's network. For example, the management worker may handle orchestration or discovery tasks for the central platform, potentially using plugins. The management worker may execute provider-specific Application Programming Interface (API) calls (e.g., to run discovery scans locally) then aggregate the results before sending them back to the central platform.

The system also supports dynamic execution of tasks through plugins provided by the central platform. These plugins can be loaded and executed by the management worker as needed, allowing for resource management without requiring frequent updates to the management worker itself. In some aspects, the management worker may download and execute plugin code from the central platform to perform local processing.

Additionally, the management worker may facilitate remote host console access to provider-specific computing resources. In some aspects, a user attempting to access a remote console may do so through the management platform or the management worker, depending on network conditions. For example, if the user device is geographically closer to the management worker than to the management platform, the management worker may relay host console data directly to the user device to reduce latency. Likewise, if network conditions favor routing through the management platform, console access may be facilitated through that path.

The distributed worker architecture may allow for more efficient management of resources across multi-cloud environments while maintaining network performance and security. It may be useful for scenarios involving geographically distributed resources, hybrid cloud architectures, environments with specific network security requirements, or the like.

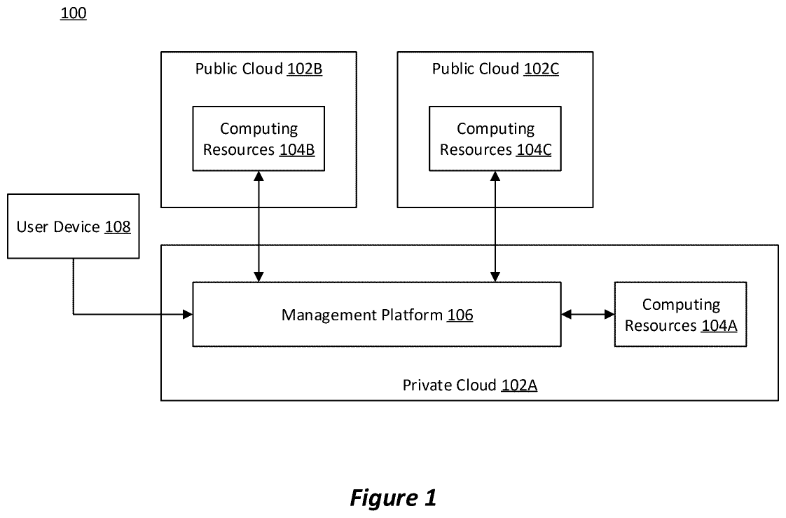

FIG. 1 is a block diagram of a cloud computing management environment 100, according to some implementations. The management environment 100 may include multiple clouds 102 (including a private cloud 102A and one or more public clouds 102B, 102C), a management platform 106, and a user device 108. This architecture represents a hybrid cloud approach for an organization, combining private and public cloud resources under centralized management while maintaining data privacy and security.

The private cloud 102A may be a privately accessible computer network under the organization's control. In some aspects, it may provide dedicated computing resources and infrastructure that are not shared with other organizations. The private cloud 102A may offer enhanced security and customization options compared to public cloud offerings. In some cases, it may allow the organization to maintain sensitive data and critical workloads on-premises while still leveraging cloud technologies and architectures. The private cloud 102A may be managed and operated by the organization's IT staff, providing greater control over resource allocation, security policies, and compliance measures.

The public clouds 102B, 102C may be publicly accessible computer networks operated by cloud providers. In some aspects, they may provide shared computing resources and infrastructure that can be utilized by multiple organizations. The public clouds 102B, 102C may offer organizations scalable and on-demand access to computing power, storage, and various services. In some cases, they may allow organizations to rapidly provision resources without large upfront investments in hardware and infrastructure. The public clouds 102B, 102C may be managed and operated by third-party cloud service providers, offering services and APIs for resource allocation and management. In some implementations, they may provide built-in redundancy and geographic distribution of resources to enhance reliability and performance. The public clouds 102B, 102C may be operated by different service providers, allowing organizations to leverage the unique strengths and capabilities of multiple cloud platforms.

The clouds 102 include computing resources 104 (e.g., computing resources 104A, computing resources 104B, and computing resources 104C for, respectively, the private cloud 102A, the public cloud 102B, and the public cloud 102C). The computing resources 104 may include various types of resources that can be utilized to perform computational tasks, store data, and the like. In some aspects, these resources may include virtual machines, containers, serverless functions, storage volumes, databases, networking components, and other cloud-based services. The computing resources 104 may be dynamically scalable, allowing for flexible allocation based on demand. In some cases, the computing resources 104 may include specialized hardware such as GPUs for machine learning tasks or FPGAs for custom acceleration. The computing resources 104 may also encompass platform services like managed Kubernetes clusters, serverless platforms, or IoT device management systems. Additionally, the computing resources 104 may include software-defined infrastructure components that can be programmatically controlled and configured. The specific types and configurations of computing resources 104 may vary between the private cloud 102A and public clouds 102B and 102C, reflecting the different capabilities of each environment.

The management platform 106 may serve as a central control point in the management environment 100, coordinating interactions between the various components (including the computing resources 104). In some implementations, the management platform 106 may be deployed within the private cloud 102A. In other implementations, the management platform 106 may be deployed within another part of an organization. The management platform 106 may control the computing resources 104A within the private cloud 102A and the computing resources 104B, 104C in the public clouds 102B, 102C. Specifically, the management platform 106 may send instructions to and receive information from the computing resources 104, which may allow for efficient allocation and management of resources across the clouds 102.

In some cases, the hybrid architecture of the management environment 100 may enable the organization to maintain sensitive workloads and data within their private cloud 102A while leveraging the scalability and cost-effectiveness of public clouds 102B, 102C for other operations. The management platform 106 may provide a unified view of the computing resources 104, regardless of location, allowing for consistent policies and management practices across the entire environment.

The user device 108 may be connected to the management platform 106, allowing users to interact with and control the management platform 106. This may enable administrators to manage computing resources 104 across private and public clouds from a single interface, streamlining operations and reducing complexity. This may also enable end-users (e.g., non-administrators) to access computing resources 104 as permitted by their roles and permissions. Specifically, the management platform 106 may provide self-service capabilities for end-users to provision and manage resources within defined policies and limits set by administrators.

The management platform 106 may provide a unified view of resources across multiple cloud providers and on-premises infrastructure. This unified view may allow an administrator using a user device 108 to monitor and manage the computing resources 104 across the private cloud 102A and public clouds 102B, 102C from a single interface. In some aspects, the management platform 106 may aggregate data from various sources and present it in a consistent, normalized format, enabling users to easily compare and analyze resource utilization across different environments. The normalization process may involve transforming definitions for provider-specific computing resources 104 into defined schemas, creating a standardized representation of diverse resource types. This transformation may allow the management platform 106 to handle heterogeneous data from different cloud providers and on-premises systems uniformly. The defined schemas may capture the requisite attributes and relationships of resources, enabling the platform to maintain a coherent view of the entire infrastructure landscape. By normalizing the data, the management platform 106 may facilitate cross-provider comparisons, simplify resource management tasks, and provide a foundation for advanced analytics and optimization strategies.

In addition to unified visibility, the management platform 106 may offer unified control of the computing resources 104. The platform may leverage APIs provided by the computing resources 104 to enable centralized management and orchestration. This unified control may allow administrators to perform actions such as provisioning, scaling, and configuring resources across multiple environments from a single point of control. The management platform 106 may abstract away the particularities of individual provider interfaces, presenting a consistent set of management operations that can be applied across heterogeneous computing resources 104. This unified control approach may streamline management and orchestration operations, including day-2 operations.

The management platform 106 may discover and inventory computing resources 104 across the clouds 102. This discovery process may involve periodic scanning and synchronization to maintain an up-to-date view of available resources. The platform may automatically detect new resources, changes to existing resources, and resource removals across both private cloud 102A and public clouds 102B, 102C. The discovered computing resources 104 may be mapped to a normalized data model (subsequently described) for the platform, enabling consistent representation regardless of the source cloud. The discovery process may capture detailed metadata about computing resources 104, including relationships between resources, configuration settings, and operational state. This comprehensive resource discovery may enable the management platform 106 to maintain an accurate inventory of infrastructure components and their dependencies across the entire management environment 100.

The management platform 106 may manage user access and authentication within the system. This functionality may allow administrators to control the resources and capabilities end-users can access through the user devices 108. The platform may implement role-based access control (RBAC) to define and manage user permissions across the entire management environment 100, ensuring that users are limited to having access to the resources and functions appropriate for their roles. In some implementations, the management platform 106 may layer a user authentication and authorization framework over existing frameworks (if any) of the computing resources 104. For example, the management platform 106 may have a master API key to a computing resource 104 and may control how the computing resources 104 are accessed by users based on its own authentication and authorization system. The platform may map user identities and roles across different systems, providing a unified access model that spans heterogeneous environments. In some cases, the management platform 106 may integrate with existing authentication systems, enabling single sign-on capabilities.

The management platform 106 may implement a comprehensive security and compliance framework across the management environment 100. This framework may include automated security scanning of computing resources 104, continuous compliance monitoring, and policy enforcement during resource provisioning and management. The platform may integrate with security tools and services to perform vulnerability assessments, configuration audits, and security monitoring of resources across clouds 102. In some implementations, the management platform 106 may enforce security policies during provisioning, automatically configuring security controls and validating compliance requirements as resources are deployed. The platform may maintain audit trails of actions performed on computing resources 104, enabling organizations to track changes and demonstrate compliance with security requirements. Security policies may be defined and enforced consistently across the private cloud 102A and the public clouds 102B, 102C, ensuring uniform security controls regardless of resource location.

The management platform 106 may provide self-service capabilities to users of the user device 108. An end-user may request and provision resources through a user device 108 within predefined limits and policies set by administrators. In some aspects, the management platform 106 may present different interfaces or options to users based on their roles or permissions, allowing for customized self-service experiences while ensuring compliance with organizational policies. The self-service capabilities may be constrained by configuration settings defined within the management platform 106 by the organization. For example, administrators may set resource quotas, cost thresholds, or approved computing resources 104 that limit what end-users can provision. The management platform 106 may enforce these constraints automatically when processing self-service requests. Additionally, the management platform 106 may provide approval workflows for certain requests requiring additional authorization before provisioning. This allows organizations to enable user-driven provisioning while maintaining appropriate governance and control over resource usage. The platform may support contextually aware deployments, considering user permissions and group participation when determining where and how to provision resources.

The management platform 106 may implement an application-centric approach to resource management, allowing for the orchestration of complete application stacks rather than individual infrastructure components. This approach may allow users to request and manage entire applications, with the platform automatically determining and provisioning suitable computing resources 104 for the application across appropriate clouds 102, as specified by organizational policies and system configurations. The management platform 106 may maintain application context throughout the resource lifecycle, understanding relationships between application components and their supporting infrastructure. In some implementations, the management platform 106 may provide application-level monitoring, scaling, and lifecycle management capabilities. This application-centric model may abstract away infrastructure complexity, allowing users to focus on orchestrating and managing applications while the platform handles the orchestration of underlying resources and day-2 aspects. The management platform 106 may track application dependencies and requirements, using this information to make intelligent decisions about resource placement and configuration across the private cloud 102A and public clouds 102B, 102C.

The management platform 106 may provide streamlined lifecycle management of applications, from initial deployment through scaling and updates. This may include capabilities for monitoring application performance, automating scaling operations, and managing updates or patches. Users may be able to manage the entire application lifecycle through a user device 108, with the management platform 106 coordinating the requisite actions across the relevant computing resources 104 in the private cloud 102A or public clouds 102B and 102C.

The management platform 106 may integrate with various external tools and services that support the computing resources 104. These integrations may include IP address management (IPAM) systems for network address allocation, load balancers for traffic distribution, monitoring tools for performance tracking, backup systems for data protection, security scanners for vulnerability detection, domain name system (DNS) providers for name resolution, and the like. The management platform 106 may coordinate with these external tools and services during orchestration and management. For example, when configuring a computing resource 104 as part of an application's orchestration, the management platform 106 may interact with an IPAM system to allocate an IP address, a DNS provider to register a hostname, and a load balancer to configure traffic routing. The platform may maintain associations between computing resources 104 and related external services throughout the resource lifecycle, ensuring proper cleanup and resource release when resources are decommissioned. These integrations may be configured at the organization level and may apply across resources in both the private cloud 102A and public clouds 102B, 102C.

The management platform 106 may provide capabilities for tracking and metering resource usage to enable cost management and optimization. This may involve collecting detailed usage data from the computing resources 104 across the clouds 102 and presenting it in a unified format. The platform may aggregate costs and bills from the various computing resources 104 to provide consolidated financial reporting. In some aspects, the management platform 106 may implement FinOps practices to align technology spending (on the computing resources 104) with business objectives of the organization. Users may access this data through a user device 108, gaining improved visibility into resource utilization and dependencies across the entire IT landscape. The management platform 106 may provide user interfaces for analyzing this data, helping users identify opportunities for cost optimization or efficiency improvements. In some cases, the platform may enable chargeback or showback reporting to allocate costs to specific business units or projects.

The management platform 106 may provide a comprehensive, provider-agnostic API that enables users to script and automate operations across heterogeneous cloud environments. This API may abstract away the differences between various cloud providers and on-premises systems, presenting a unified interface for managing computing resources 104 regardless of their location or underlying technology. Through this API, users can programmatically control aspects of resource provisioning, configuration, and lifecycle management across the private cloud 102A and public clouds 102B, 102C using consistent commands and data structures. In some implementations, the API may support various programming languages and offer client libraries to facilitate integration with existing tools and workflows. The provider-agnostic nature of the API may allow organizations to develop portable automation scripts and tools that can operate across different cloud environments without modification, reducing vendor lock-in and enhancing flexibility in multi-cloud strategies. These programmatic interfaces may enable advanced automation scenarios, support infrastructure-as-code practices, and facilitate integration with continuous integration and continuous delivery pipelines as well as other DevOps tools.

The management platform 106 may normalize data from heterogeneous sources into a common data model. Example sources of data may include data from computing resources 104 across the clouds 102, financial systems, management tools, and the like. This normalization may enable the management platform 106 to orchestrate workflows that span multiple environments and domains, considering the unique characteristics and capabilities of each resource type.

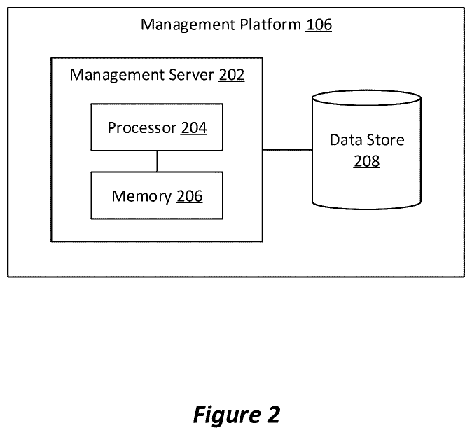

FIG. 2 is a block diagram of hardware components of the management platform 106, according to some implementations. The management platform 106 may include one or more management servers 202 and one or more data stores 208. Only one management server 202 and data store 208 are shown in this example.

In some aspects, the management server 202 may serve as a central component of the management platform 106, performing administrative functions. These functions may include managing and/or orchestrating provider-specific computing resources, normalizing heterogeneous data, processing service requests, and the like.

The management server 202 may include suitable components for performing any desired functionality. One or more modules within the server may be partially or wholly embodied as software and/or hardware for performing any functionality described herein. For example, a server may include a processor 204 and a memory 206. The processor 204 may be a microprocessor, an application-specific integrated circuit, a microcontroller, or the like. The memory 206 may be a non-transitory computer-readable medium that stores instructions for execution by the processor 204. The instructions, when executed by the processor 204, may cause the processor to perform any functionality described herein.

The data store 208 may provide storage capacity for maintaining data related to the managed resources and services. In some aspects, the data store 208 may include database servers, file servers, network-attached storage (NAS) devices, or the like for storing the normalized data representing heterogeneous provider-specific computing resources. The data store 208 may be implemented using various storage technologies, such as relational databases, NoSQL data stores, distributed file systems, object storage, block storage, or the like depending on the specific requirements of the management platform 106.

In some cases, the management platform 106 may include redundant components or distributed architectures to provide high availability and fault tolerance. For example, the management server 202 may be implemented as a cluster of servers, with the workload distributed across multiple physical or virtual hosts. Likewise, the data store 208 may be implemented using a distributed database system to achieve data redundancy and availability. The management platform 106 may also incorporate load balancing mechanisms to distribute incoming requests across multiple servers.

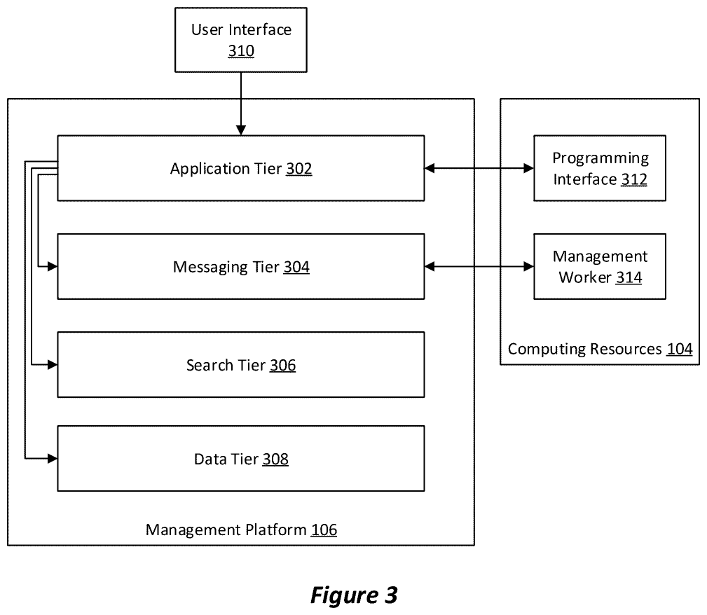

FIG. 3 is a block diagram of the software architecture of the management environment 100, according to some implementations. The diagram illustrates the various software components and tiers that make up the management platform 106 and the computing resources 104.

The management platform 106 may be implemented using a tiered architecture to organize its functionality. This architecture may include an application tier 302, a messaging tier 304, a search tier 306, and a data tier 308. The management platform 106 may include more or fewer tiers than shown in this example. The specific number and organization of tiers may vary depending on the requirements and design choices of the system.

The application tier 302 may form the core of the management platform 106, handling the primary business logic and orchestration tasks. The application tier 302 may control the other tiers within the management platform 106: the messaging tier 304, the search tier 306, and the data tier 308. In some aspects, the application tier 302 may include software applications for processing service requests, orchestrating resources, managing workflows, and the like. The application tier 302 may interact with external computing resources 104 and may coordinate activities across different cloud environments. In some implementations, the application tier 302 may be built using a microservices architecture, allowing for scalability and flexibility. The application tier 302 may leverage data stored in the data tier 308 (e.g., using a normalized data model) to make intelligent decisions about resource allocation and configuration. In some implementations, the application tier 302 may run nginx for serving a web interface, Apache Tomcat for handling business logic, and Apache Guacamole for providing remote access and control capabilities. Other applications may run in the application tier 302.

The messaging tier 304 may facilitate communication between different components of the management platform 106 and external systems. The messaging tier 304 may implement a publish-subscribe model or utilize protocols such as Advanced Message Queuing Protocol (AMQP), running a message broker like RabbitMQ, to provide reliable and asynchronous communication between various components of the management platform 106 and computing resources 104. In some aspects, the messaging tier 304 may include a load balancer that receives messages from the application tier 302 and distributes them to message brokers.

The search tier 306 may provide indexing and search capabilities for the management platform 106. This tier may enable efficient querying and retrieval of information across the normalized data model stored in the data tier 308. In some implementations, the search tier 306 may utilize a non-transactional database such as Elasticsearch to provide high-performance full-text search and analytics capabilities. The use of Elasticsearch or similar technologies may allow for rapid searching and aggregation of large volumes of data from heterogeneous sources. This search functionality may support various operations within the management platform 106, such as resource discovery, monitoring, and reporting. The search tier 306 may index data from multiple sources, including the normalized data model, logs, and metrics, to provide a unified search interface across the entire management environment.

The data tier 308 may be responsible for data storage and management within the management platform 106. This tier may implement a normalized data model that represents the heterogeneous provider-specific computing resources in a standardized format. In some aspects, the data tier 308 may utilize a transactional database (such as MySQL, PostgreSQL, or the like) to store and manage the normalized data. Using a transactional database may provide Atomicity, Consistency, Isolation, and Durability (ACID) properties, ensuring data integrity and reliability. This may be particularly important when dealing with complex relationships and dependencies between heterogeneous resources. The data tier 308 may handle database operations such as inserting, updating, and querying the normalized data, providing a consistent and reliable data layer for the other tiers of the management platform 106.

The management platform 106 may provide a user interface 310, serving as the entry point for user interactions with the system. The user interface 310 may connect directly to the application tier 302, allowing users to initiate management and orchestration tasks, view resource status, and access other platform features.

A computing resource 104 may implement various mechanisms for interacting with the management platform 106. A programming interface 312 may provide programmatic access to the platform's functionality. The programming interface 312 may represent an API provided by a cloud provider, enabling the management platform 106 to interact with and control resources in that provider's environment. When the management platform 106 interacts with the computing resources 104 via a programming interface 312, the application tier 302 may directly access the programming interface 312, such as via web API requests.

A management worker 314 may be executed in the computing resources 104 and may interact with the management platform 106 through messaging. The management worker 314 may be a custom application executing in the cloud provider's environment. In some aspects, the management worker 314 may be a system process running on a computing device (e.g., a physical or virtual host). In some aspects, the management worker 314 may process tasks or messages and facilitate interactions between the management platform 106 and the specific cloud environment by sending information to the management platform 106. For example, the management platform 106 may interact with the computing resources 104 by sending messages to the management worker 314 via the messaging tier 304.

In some implementations, the management worker 314 may act as an intermediary between the management platform 106 and agents running on the computing resources 104. The management worker 314 may perform certain tasks as delegated thereto by the management platform 106. For instance, the management worker 314 may collect data from the computing resources 104 and return it to the management platform 106. The management worker 314 may also orchestrate components of the computing resources 104 based on instructions received from the management platform 106.

The management worker 314 may aggregate and multiplex communications from multiple agents running on computing resources 104 within a provider. This may potentially reduce the number of network connections to the management platform 106 from the provider. In some cases, the management worker 314 may facilitate remote host console access to the agents in the computing resources 104, act as a proxy for cloud provider APIs, and dynamically execute plugin code to perform local processing and optimization. This approach may allow organizations to manage resources across multi-cloud environments more efficiently, while maintaining security and potentially reducing network overhead.

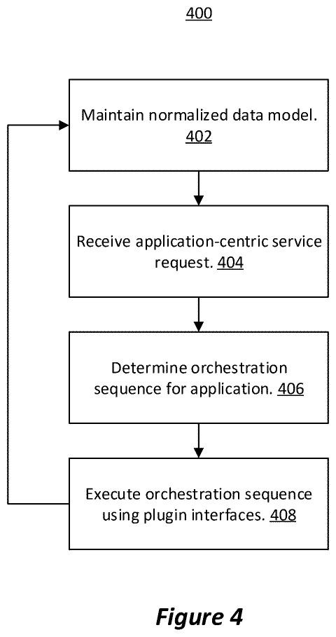

FIG. 4 is a block diagram of a management method 400, according to some implementations. The management method 400 will be described in conjunction with the management environment 100 of FIGS. 1-3. The management method 400 may be used for managing and orchestrating heterogeneous cloud resources through a normalized data model. The management method 400 may be implemented in the management environment 100. Specifically, the management platform 106 may perform the management method 400.

At step 402, the management platform 106 maintains a normalized data model of heterogeneous data from the provider-specific computing resources 104. The normalized data model may be built by obtaining heterogeneous data from various providers, which data is then normalized into the normalized data model. For example, the management platform 106 may perform data normalization in the application tier 302. In some implementations, the normalizing of the heterogeneous data is performed by the management platform 106. The normalization process transforms diverse definitions of computing resources 104 into defined schemas representing relationships and dependencies across different computing resources 104, regardless of origin. Thus, the management platform 106 has a common format for describing and managing computing resources 104 from any provider.

For example, the normalization process can include converting various configurations (of virtual machines, IP address managers, etc.) into common formats that generically represent the configurations. For example, the management platform 106 may convert VMware-specific virtual machine attributes, AWS-specific instance properties, or InfoBlox IPAM configurations into their respective common representation. In the case of resource allocation, what may be called a resource pool in VMware, a VPC in Amazon, or a resource group in Azure, can be normalized into a common representation in the data model. The normalization may preserve provider-specific features while maintaining common denominator functionality across providers. Continuing the previous example, configurations of an IP address management tool like InfoBlox can be normalized such that network resources work seamlessly with network configurations from various cloud providers without requiring custom integration code for each combination.

The normalized model maintains relationships between components while preserving provider-specific capabilities, enabling cross-service interactions through common data abstractions. The model tracks relationships between applications and supporting infrastructure, enabling services that don't natively know about each other to interact through the normalized data model. The normalization allows the system to represent, for example, a virtual machine and a container in a common format, facilitating the management of resources across different technological paradigms through a common abstraction layer.

The normalized data model is stored in a database. For example, the management platform 106 may store the normalized data in the data tier 308. The stored model captures resource relationships, dependencies, and configurations in a format that can be efficiently queried and updated by the application tier 302. The data tier 308 may leverage a transactional database to maintain data integrity across the normalized representations. The transactional database schema includes tables that normalize infrastructure components and their relationships in the management environment. For example, a virtual machine may be represented in one table and the virtual machine's network card may be represented in another table, with the network card's IP address and connected switch tied off in related tables through the normalized data model. The structure tracks relationships and dependencies across heterogeneous resources while maintaining data consistency.

The data tier 308 interacts with the application tier 302 through database operations for storing and retrieving normalized data. The messaging tier 304 coordinates communication between the data tier 308 and other components through, for example, message queues, enabling asynchronous data operations. The search tier 306 may utilize a non-transactional database, such as Elasticsearch, to index the normalized data, enabling high-performance searching and aggregation across the normalized model.

The search tier 306 provides indexing and search capabilities across the normalized data model stored in the data tier 308. This enables efficient querying and retrieval of information about resources, relationships, and configurations stored in the data tier 308. The search functionality, provided by the search tier 306, supports various operations within the management platform 106, such as resource discovery, monitoring, and reporting.

The heterogeneous data may be collected by the management platform 106 through various approaches. In some cases, the application tier 302 may directly interact with the programming interface 312 of the computing resources 104 to gather data. This approach may involve making API calls to cloud provider services or on-premises systems to retrieve information about resource configurations, states, and relationships. Alternatively, the messaging tier 304 may collect data by communicating with the management worker 314 deployed within the computing resources 104.

The management worker 314 may aggregate data from multiple agents or resources within its environment and send this information to the messaging tier 304 using a messaging protocol. In some implementations, the management worker 314 may directly interact with resources that do not have a programming interface 312 usable by the application tier 302. For example, the management worker 314 may use provider-specific libraries or classes, from a provider-specific Software Development Kit (SDK), to communicate with resources and collect data, then relay that information back to the management platform 106 for normalization and storage. Additionally or alternatively, the management worker 314 may interact with the programming interface 312 (when available) of a resource. The combination of these approaches may allow the management platform 106 to gather comprehensive data about heterogeneous resources across diverse environments, even when those resources are legacy components that may not offer a programming interface usable by the management platform 106.

At step 404, a service request for application deployment is received through, for example, a user or programming interface. In some aspects, the management platform 106 may provide self-service capabilities, allowing end-users to request and provision applications. The application tier 302 may receive the service request through the user interface 310. The service request may specify application requirements that span multiple provider-specific computing resources. Using the normalized data model maintained at step 402, the management platform 106 can process the application deployment request based on the request's context, such as whether the request comes from a QA department or production environment.

Thus, the management platform 106 implements an application-centric approach to resource management, allowing for the self-service orchestration of complete application stacks rather than individual infrastructure components. This approach allows end-users to request and manage entire applications, with the platform automatically determining and provisioning suitable computing resources for the application across appropriate clouds, as specified by organizational policies and system configurations. For example, a service request may request deployment of a multi-tier application. Based on the normalized data model, organization policies, and configurations, the management platform 106 may determine requisite compute resources to deploy the requested application. For example, the management platform 106 may form an orchestration plan that specifies compute resources from VMware, a network configuration via InfoBlox, and a load balancer configuration. In another example, a request may specify deploying a WordPress application, which requires the management platform 106 to identify and coordinate components, including web servers, database servers, storage, and network configurations. When deploying a web application, the request may specify requirements for a web server and a database server, where the database server is to be provisioned before the web server due to dependency requirements. The normalized data model enables the management platform 106 to deploy components in a way that makes them work together even though they don't natively know about each other.

At step 406, the management platform 106 determines an orchestration sequence to handle the service request. The requests are processed through the normalized data model to identify the requisite resources and dependencies. The normalized model enables the management platform 106 to understand the requisite individual resources and their relationships and dependencies across different providers. Organization policies and the end-user's request context may also influence orchestration.

The management platform 106 determines resource placement and configuration based on the application context and organizational policies. For example, the same application service request might result in different resource allocations and configurations depending on whether it's for development, testing, or production use. This may include deploying to specific cloud providers or resource pools based on the requesting group's role or applying different backup, monitoring, and security policies based on the deployment context. For example, when a QA team requests a testing environment, the management platform 106 may deploy resources to a lower-cost environment with different performance characteristics than a production deployment request from an operations team. The normalized data model allows contextual deployment by enabling different orchestration workflows to be seamlessly created and executed for each deployment environment or context transparently to the end-user.

The normalized data model enables the platform to maintain contextual differences using the same underlying resource definitions and relationships. In some aspects, the normalized model may transform complex orchestration processes into automated workflows. What traditionally requires multiple teams and extended timeframes can potentially be orchestrated as an automated sequence completed in minutes through the management platform 106.

At step 408, the management platform 106 executes the orchestration sequence. The orchestration may leverage the messaging tier 304 to coordinate actions across distributed resources. The normalized data model can enable the management platform 106 to sequence operations, such as allocating IP addresses before configuring network interfaces or deploying database instances before web servers. The orchestration process may include configuring day-2 operations such as backups, compliance automation, and security scan schedules.

The management platform 106 may utilize programming interfaces 312 and/or worker 314 within the computing resources 104 to orchestrate provider-specific computing resources in manners expected by each provider. In some implementations, a management worker 314 may receive commands from the management platform 106 through the messaging tier 304 to execute provider-specific operations. When provisioning resources, the management worker 314 may create a secure connection back to the management platform 106 and establish a command bus for coordinating actions between the platform and provider environments. The management worker 314 can operate behind load balancers for scalability and to process cloud API requests from remote locations. The management worker 314 may interact with computing resources 104 using provider-specific libraries or through the programming interface 312, allowing for flexible integration with various cloud environments and legacy systems. In some implementations, the management platform 106 may directly orchestrate resources via the programming interfaces 312 (when available) instead of using a management worker 314.

The management platform 106 utilizes a plugin architecture that generates plugin interfaces for service providers. The plugin architecture may create code templates with predefined integration points, allowing providers or end-users to implement their specific functionality while maintaining consistent interaction with the normalized data model. For example, an end-user may integrate an IPAM with the management platform 106 by creating a plugin for the IPAM. To create the plugin, the system can generate a code skeleton with defined methods that the provider fills in to allocate resources (e.g., IP addresses) or perform other specific operations. The orchestration sequence may be performed using the plugin interfaces.

The plugins are loaded at runtime through an isolated class loader, potentially within a JVM running in the application tier 302. Each plugin implements common interfaces that are clearly defined through Java documentation. The management platform 106 provides a context that allows plugins to call back into the platform and save data from computing resources 104 in the normalized format.

The database schema within the data tier 308 may support the plugin architecture by providing standardized ways to store and retrieve normalized data. When plugins interact with the management platform 106, they can store their data in the normalized format through defined interfaces, allowing the data to be used consistently across the platform regardless of the original provider format.

The plugin architecture enables runtime extension of computing resources 104 integration without modifying the core code of the management platform 106. Developers can use the generated plugin code templates when integrating new providers rather than writing custom integration code. The plugin framework handles the communication and data transformation between the provider-specific implementations (of the computing resources 104) and the normalized data model, allowing new integrations to leverage existing abstractions of the management platform 106.

The management platform 106 may orchestrate provider-specific computing resources by leveraging the normalized data model and plugin interfaces. During orchestration, the platform may invoke relevant plugins to interact with specific provider APIs or services. These plugins may translate orchestration commands from the normalized model into provider-specific API calls, allowing the management platform 106 to manage diverse resources through a unified programming interface. For example, when allocating storage, a plugin for a particular cloud provider may convert a generic storage request into the appropriate API calls for that provider's block storage service. The plugin architecture may allow the orchestration process to seamlessly integrate new providers and resource types without modifying the core orchestration logic, enhancing the platform's extensibility and adaptability to evolving cloud ecosystems.

The management platform 106 runs code from the plugins that interfaces with provider-specific APIs (e.g., VMware, InfoBlox, etc.) of the computing resources 104. At the same time, the normalized data model in the data tier 308 maintains the standardized representation of the operations. For example, a management worker 314 may execute provider-specific API calls to InfoBlox when allocating an IP address. Still, the results of those API calls are transformed and stored in the normalized model, enabling other components to interact with that IP address assignment without understanding InfoBlox-specific implementations.

The orchestration process can adjust its flow based on each step's outcomes. For instance, if a call to a third-party policy API indicates additional requirements that call for extra steps in the orchestration process, the management platform 106 can inject the additional steps into the orchestration workflow. Each step in the orchestration flow has the capability of affecting subsequent steps, allowing for dynamic adaptation based on runtime conditions.

For application lifecycle management, the orchestration by the management platform 106 may include deploying various components and configuring day-2 operations. This may include deploying application code, obtaining an IP address, configuring monitoring systems, and setting up load balancer automation. When the application instance is decommissioned at the end of its lifecycle, the orchestration achieves proper cleanup, such as releasing the IP address for reuse. Throughout the application lifecycle, the process leverages the normalized data model to coordinate actions across different service providers while maintaining consistency through standardized interfaces. The management platform 106 handles both aspects of orchestration, including initial deployment and eventual teardown, providing comprehensive lifecycle management for applications across heterogeneous environments. The orchestration process through the normalized data model may transform what traditionally requires multiple teams and extended timeframes into an automated sequence of operations that may be provided in a self-service manner to end-users.

Following the orchestration operations, the normalized data model may be updated to reflect changes implemented during orchestration. In implementations, the data tier 308 performs the updating operation. For example, when an IP address is allocated during orchestration, the normalized model is updated to reflect this IP address allocation and its relationships to other resources. The updates maintain the accuracy of resource states, relationships, and configurations across the heterogeneous environment.

The search tier 306 may index the updates to enable efficient querying of the current environment. The indexing allows the management platform 106 to discover and monitor the environment, synchronizing changes to maintain an accurate inventory of infrastructure components and their dependencies. The management platform 106 can discover existing resources in the cloud and continue synchronizing any changes on a near real-time basis for provisioned resources.

The updated model can provide a foundation for subsequent orchestration operations, ensuring decisions are based on the current infrastructure state. For example, when an application instance is later modified or removed, the management platform 106 can use the updated model to understand related components that need to be reconfigured or cleaned up, such as releasing IP addresses or updating load balancer configurations. The discovery process can include monitoring installed software packages, which can be used for security scanning and compliance verification.

Maintaining, orchestrating, and updating the normalized data model establishes a continuous feedback loop where the model evolves with the infrastructure. This enables the management platform 106 to maintain consistency across heterogeneous resources while supporting complex orchestration scenarios. The normalized model allows provider-specific computing resources to interact through common interfaces while preserving their unique capabilities and requirements.

The management platform 106 may delegate certain operations to the management worker 314, enhancing the efficiency and flexibility of the system. During step 402, the management worker 314 may be utilized to collect data from computing resources 104 within its local environment and forward that data to the management platform 106, potentially reducing network traffic and improving response times. Similarly, in step 408, the management worker 314 may be employed to execute orchestration tasks, leveraging its proximity to the computing resources 104. By offloading these operations to the management worker 314, the management platform 106 may achieve more efficient resource utilization and improved scalability, particularly in distributed or hybrid cloud scenarios. This approach may allow for more granular control and optimization of operations across diverse computing environments.

The aforementioned plugin architecture may extend to the management worker 314. The management platform 106 may provide plugins to the management worker 314, enabling it to perform these delegated tasks effectively. The plugins may contain specific logic for data collection, resource discovery, or orchestration operations tailored to particular provider environments.

The management worker 314 may allow for enhanced network security within the management environment. In some implementations, the management worker 314 can establish an outbound connection to the management platform 106, which may be utilized for network operations in steps 402 and 408. This outbound connection approach allows the computing resources 104 to be effectively managed even in secure network environments where inbound connections to the computing resources 104 are prohibited. By leveraging this outbound connection, the management worker 314 can facilitate communication between the management platform 106 and the computing resources 104 while maintaining the security posture of the network. This may enable organizations to maintain strict firewall rules and network segmentation while still benefiting from centralized management and orchestration capabilities. The management worker 314 may act as a secure intermediary, securely relaying commands and data between the management platform 106 and the computing resources 104, thus providing a way to bridge security boundaries and enable resource management in tightly controlled network environments.

The management worker 314 may be implemented as a distributed system of workers across multiple providers or geographical locations. In some aspects, multiple instances of the management worker 314 may be deployed across different cloud environments, data centers, or network segments. This distributed architecture may allow for improved scalability, fault tolerance, and performance optimization. For example, a management worker 314 may be deployed in each distinct cloud provider environment or in different regions within a single provider's infrastructure. These distributed workers can operate independently while coordinating through the central management platform 106.

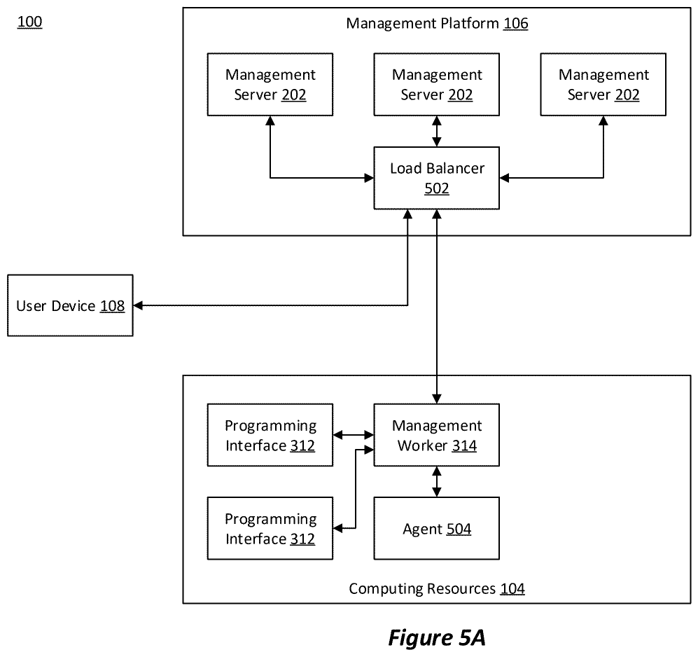

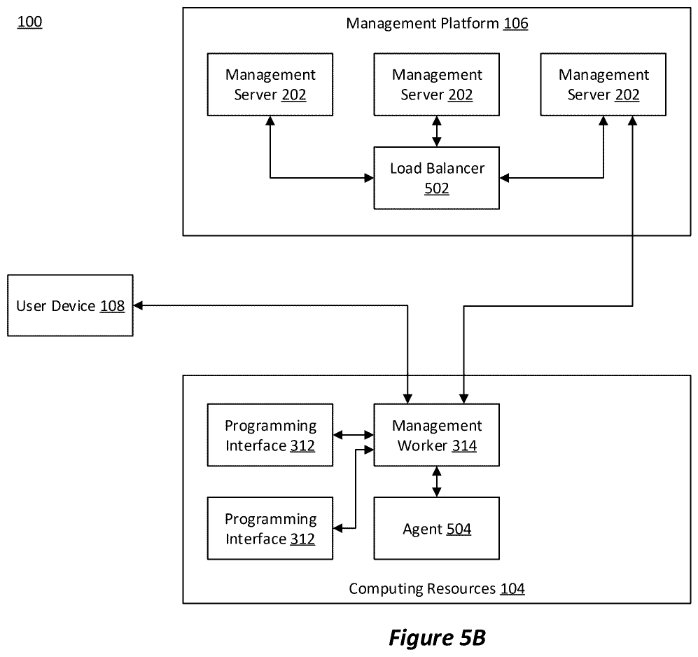

FIGS. 5A-5B are block diagrams of the cloud computing management environment 100, according to some implementations. FIGS. 5A and 5B illustrate the flow of data within the management environment 100 during various operations. A management worker 314 may be utilized to facilitate communication and data transfer between components. The management worker 314 may aggregate and multiplex messages from multiple components running on computing resources 104. This may potentially reduce the number of connections to the central management platform 106 from the computing resources 104. In some aspects, the management worker 314 may act as a proxy for cloud provider APIs, dynamically execute plugin code to perform local processing, and facilitate remote host console access. FIG. 5A shows the flow of data when the management worker 314 is utilized for aggregating communications with the computing resources 104, while FIG. 5B shows the flow of data when the management worker 314 is used to facilitate remote host console access.

Referring to FIG. 5A, the management platform 106 may include multiple management servers 202 and a load balancer 502. The load balancer 502 may distribute incoming requests across the management servers 202 to optimize performance and resource utilization.

A user device 108 may interact with the management platform 106, potentially utilizing the load balancer 502 to achieve efficient distribution of requests. In some aspects, end-users may submit service requests through the user device 108, which may be routed to an available management server 202 via the load balancer 502. These service requests may include operations such as provisioning new resources, modifying existing configurations, initiating orchestration workflows, and the like.

The computing resources 104 for a provider may include a management worker 314. The management worker 314 may connect to a management server 202 (via the load balancer 502) of the management platform 106. In some aspects, the management worker 314 may interface with programming interfaces 312 and an agent 504 of the computing resources 104. The management worker 314 may utilize the programming interfaces 312 and agent 504 to interact with and manage the computing resources 104.

The agent 504 may be a software component installed on individual computing resources 104, such as virtual machines, containers, or physical servers. In some aspects, the agent 504 may be a system process running on a computing device (e.g., a physical or virtual host). The agent 504 may establish an outbound connection to either the management platform 106 directly or to a configured worker 314, facilitating communication. The agent 504 may collect and transmit status updates to the management platform 106, including telemetry data such as CPU usage, disk utilization, and overall health metrics. These status updates may typically be sent at regular intervals, such as every 30 seconds. Additionally, the agent 504 may receive commands from the management platform 106 or worker 314 and execute them, enabling remote management tasks such as software installation or configuration changes. The agent 504 may also send responses back to the management platform 106 after executing these commands. In some implementations, the agent 504 may have specialized capabilities, such as Kubernetes awareness, allowing for management of container orchestration environments.

The management worker 314 may be stateless. This stateless design may allow the management worker 314 to be easily scaled or replaced without maintaining complex state information. The stateless nature of the management worker 314 may also enhance fault tolerance, as any instance of the management worker can handle requests without relying on previously stored state. The management worker 314 may launch and connect to the management platform 106, operating under the direction of the management platform 106 without needing to maintain its own persistent state. This approach may allow workers 314 to be dynamically provisioned and deprovisioned as needed to handle varying workloads. The stateless design may also simplify updates and maintenance of the management worker 314, as each instance can be replaced with a new version without concerns about migrating state information. Furthermore, the stateless design may allow multiple management workers 314 to operate in a distributed manner.

The management worker 314 may be a management gateway for a provider that acts as an intermediary between the management platform 106 and the agents 504 running on the computing resources 104 of the provider. The management worker 314 may aggregate and multiplex communications from multiple agents 504 running on the computing resources 104 of the provider. That is, the management worker 314 may forward requests from the management platform 106 to the appropriate agent 504, and may forward responses from the agent 504 to the management platform 106. This may potentially reduce the number of connections to the management platform 106 from the provider. The management worker 314 may establish connections with many agents 504, allowing it to efficiently relay information between the agents and the management platform 106. This configuration may allow the management platform 106 to connect to a single management worker 314 for a provider, instead of individually communicating with many components of the provider.

The management worker 314 may establish an outbound network connection with the management platform 106. After the connection is initiated by the management worker 314, the management worker 314 and management platform 106 may communicate over this connection. This outbound connection approach may allow the computing resources 104 to be effectively managed even in network environments where inbound connections to the computing resources 104 are restricted. By leveraging this outbound connection, the management worker 314 may facilitate communication between the management platform 106 and the computing resources 104 while maintaining the security posture of the network. This may enable organizations to maintain firewall rules and network segmentation while still benefiting from centralized management and orchestration capabilities.

In some implementations, the outbound connection may be a WebSocket connection that egresses from the management worker 314 to the management platform 106. The management worker 314 may establish a multiplexed message stream over this WebSocket connection using a protocol such as the Streaming Text Oriented Messaging Protocol (STOMP). This multiplexed stream may allow the management worker 314 to aggregate and relay messages between multiple agents 504 on the computing resources 104 and the management platform 106 over a single persistent connection. In some aspects, the WebSocket connection may be secured using SSL/TLS encryption to protect the data being transmitted between the management worker 314 and the management platform 106.

The management worker 314 may implement error correction and/or data deduplication techniques to enhance the reliability and efficiency of communication between the management platform 106 and the computing resources 104. In some aspects, the management worker 314 may store a message history, which can be used to resend unacknowledged messages to management platform 106 or agent 504 in case of network connection disruptions. This approach may help avoid data loss during temporary network issues or service interruptions. Additionally, the management worker 314 may perform data deduplication on messages before relaying them to the management platform 106 or the agents 504. By identifying and removing redundant data across multiple messages, the management worker 314 may reduce the amount of transmitted network data, potentially improving overall system performance and reducing bandwidth usage.

The management worker 314 may interact with the computing resources 104 through various mechanisms, including the programming interfaces 312 and provider-specific libraries. This flexibility may allow the management worker 314 to leverage provider-specific functionality when managing resources, potentially enabling seamless integration with diverse cloud environments and legacy systems. For example, the management worker 314 may use a VMware SDK to interact with VMware-specific resources or an AWS SDK to manage AWS resources, which may allow provider-specific features and optimizations to be fully utilized. Furthermore, the management worker 314 may use programming interface 312 to interact with other resources that have standardized interfaces and do not require an SDK for interaction. Thus, the management worker 314 may act as a proxy for cloud provider APIs.

The management worker 314 may facilitate communication and data transfer between components of the management environment 100. As part of step 402 (see FIG. 4), the management worker 314 may utilize the programming interfaces 312 and provider-specific libraries to discover and collect data about the computing resources 104, which can then be normalized and stored in the data model maintained by the management platform 106. As part of step 408 (see FIG. 4), the management worker 314 may leverage the programming interfaces 312 and provider-specific libraries to execute an orchestration sequence, configuring and managing the computing resources 104 according to a workflow defined by the management platform 106.

The management platform 106 may provide an orchestration sequence to the management worker 314. The orchestration sequence may include a process workflow for configuring provider-specific computing resources 104 in response to a service request (received by the management platform 106). In some aspects, the management worker 314 may receive this orchestration sequence from the management platform 106 and execute it locally within the provider environment having the provider-specific computing resources 104. The management worker 314 may interpret the process workflow and configure the provider-specific computing resources 104 accordingly, potentially leveraging the programming interfaces 312 or agent 504 to implement desired changes. This approach may allow for efficient execution of complex orchestration tasks, as the management worker 314 can perform the configuration steps directly within the provider's network, potentially reducing latency and network traffic between the provider and the central management platform 106. The management worker 314 may also be able to adapt the orchestration sequence to provider-specific requirements or optimizations, enhancing the flexibility and effectiveness of the orchestration process across diverse cloud environments.

To adapt to different provider environments, the management platform 106 may, at runtime, provide a plugin (previously described) to the management worker 314, which the management worker 314 may dynamically load and use to interact with a programming interface 312. This may allow the management worker 314 to perform local processing and orchestration tasks within the provider environment. For instance, as part of step 402 (see FIG. 4), the management worker 314 may execute code from the plugin to perform data operations such as discovery of resources. Likewise, as part of step 408 (see FIG. 4), the management worker 314 may also use the plugin for orchestration operations to configure provider-specific computing resources. This approach may potentially improve performance and reduce network traffic between the provider and the central management platform 106. In some aspects, the plugins being provided by the management platform 106 may obviate the need for them to be persisted or configured at the computing resources 104, allowing the management worker 314 to remain stateless and be distributed. The management worker 314 may dynamically receive the plugins from the central management platform 106 and execute them as needed to perform tasks, without maintaining persistent state information needed to interact with the programming interfaces 312.

Additionally, the user device 108 may be used to access a remote host console for the computing resources 104, e.g., as part of a Virtual Desktop Infrastructure (VDI). In this case, the management platform 106 may facilitate a secure connection between the user device 108 and a target computing resource 104. This connection may be established through different paths depending on the network configuration. In some implementations, the host console data may be routed through the management platform 106 to the user device 108, as shown in FIG. 5A. In other cases, the management worker 314 may relay host console data directly to the user device 108, bypassing the management platform 106, as will be shown in FIG. 5B. This flexible approach may allow users to perform administrative tasks, troubleshoot issues, or monitor resource performance from their user device 108, while the management platform 106 or worker 314 handles the underlying complexity of establishing and maintaining the connection across different network environments.

Referring to FIG. 5B, the management worker 314 may be used to relay host console data directly to the user device 108, without relaying the data through the management platform 106. The use of the management worker 314 as an intermediary may be particularly beneficial in scenarios where it can provide lower-latency access to the console, such as when the user device 108 is geographically closer to the management worker 314 than to the management platform 106. This direct relay approach leverages the distributed nature of the management worker 314 to optimize console access performance. By bypassing the management platform 106, the management worker 314 can reduce network latency and potential bottlenecks, especially in geographically dispersed environments. The system may thus adapt to various network topologies and geographical distributions of resources and users. This approach not only improves user experience but also helps in load distribution, reducing the burden on the central management platform 106 for high-bandwidth console data transmission. The management worker 314 can dynamically determine the most efficient path for host console data based on network conditions and geographical proximity, further optimizing the overall system performance.

Additionally or alternatively, host console data may be sent to the management platform 106, when requested. The management worker 314 may also be used to forward console data to the management platform 106. A management server 202 may directly connect to a management worker 314 to obtain the console data, potentially bypassing the load balancer 502.

Some variations are contemplated. In some aspects, multiple workers 314 may be chained together to accommodate complex network configurations or to optimize communication across distributed environments. For example, a first worker 314 may be deployed at a provider's site, a second worker 314 may be deployed in a regional data center, and a third worker 314 may be deployed in a central location, with each worker 314 connecting to the next worker 314 in the chain before communications ultimately reach the central management platform 106. This chained configuration may allow for more efficient routing of data and commands between the management platform 106 and computing resources 104, potentially reducing latency and improving performance for distributed computing resources 104. In some implementations, each worker 314 in the chain may perform local processing or aggregation of data before passing it to the next worker 314, further optimizing the flow of information. The chaining of workers 314 may also provide additional layers of security and network segmentation, as each worker 314 may act as a secure gateway between different network zones. This flexible architecture may enable organizations to design customized management topologies that can adapt to various network constraints and security requirements.

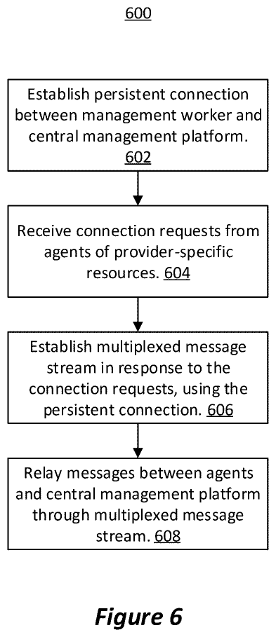

FIG. 6 is a flowchart of a worker processing method 600, according to some implementations. The worker processing method 600 will be described in conjunction with the management environment 100 of FIGS. 5A-5B. The worker processing method 600 may be implemented in the management environment 100. Specifically, the management worker 314 may perform the worker processing method 600.

The management worker 314 may perform a step 602 of establishing a persistent connection between the management worker 314 and a central management platform 106. The central management platform 106 may be deployed in a first network (e.g., a private cloud 102A or another part of an organization's infrastructure). In some aspects, the persistent connection may be a WebSocket egressing from the management worker 314 to the central management platform 106. This outbound connection approach may allow the management worker 314 to communicate with the central management platform 106 even in network environments where inbound connections are restricted.

The management worker 314 may perform a step 604 of receiving connection requests from agents 504 of provider-specific computing resources 104. The provider-specific computing resources 104 may be deployed in a second network (e.g., a public cloud 102B or 102C). The second network may be different than the first network, reflecting the hybrid or multi-cloud nature of the management environment 100. The agents 504 may be software components installed on individual computing resources 104, such as virtual machines, containers, or physical servers, responsible for collecting and transmitting status updates and executing commands.

The management worker 314 may perform a step 606 of establishing a multiplexed message stream in response to the connection requests. The multiplexed message stream may be established using the persistent connection, allowing multiple agents 504 to communicate with the central management platform 106 through a single connection. In some implementations, the multiplexed message stream may be established using the Streaming Text Oriented Messaging Protocol over the WebSocket. The multiplexed message stream may be used to communicate with the messaging tier 304 of the central management platform 106, which may utilize publish-subscribe messaging patterns or message queues to efficiently distribute messages. That is, the multiplexed message stream may be a pub-sub subscription, an ordered message queue, or the like.

The management worker 314 may perform a step 608 of relaying messages between the agents 504 and the central management platform 106 through the multiplexed message stream. The messages may include status updates from the agents 504 to the central management platform 106, such as telemetry data on CPU usage, disk utilization, overall health metrics, or the like. The messages may also include commands from the central management platform 106 to the agents 504, which may be part of orchestration sequences or management tasks. Additionally, the messages may include responses to the commands from the agents 504, providing feedback on the execution of tasks or the current state of resources.

In some aspects, the management worker 314 may perform error correction. This may involve storing a message history and resending unacknowledged messages from the message history after disruption of the persistent connection. The management worker 314 may also perform data deduplication for the messages before relaying the messages.

In some implementations, when relaying the messages, the management worker 314 may receive a plugin from the central management platform 106. The plugin may include plugin code that extends the functionality of the management worker 314. The management worker 314 may forward request messages from the central management platform 106 to the agents 504 by executing the plugin code. These request messages may be part of orchestration tasks, configuration changes, or other management or orchestration operations. The management worker 314 may then forward response messages from the agents 504 to the central management platform 106 through the multiplexed message stream.

In some implementations, when relaying the messages, the management worker 314 may forward request messages from the central management platform 106 to the agents 504 using provider-specific libraries of the agents 504. The management worker 314 may then forward response messages from the agents 504 to the central management platform 106 through the multiplexed message stream.

In some aspects, the management worker 314 may receive an orchestration sequence from the central management platform 106. The orchestration sequence may include a process workflow for the provider-specific computing resources 104 called for by a service request. This orchestration sequence may be part of an application-centric approach to resource management implemented by the management platform 106, allowing for the deployment and management of complete application stacks rather than individual infrastructure components. The management worker 314 may execute the orchestration sequence by configuring the provider-specific computing resources 104 according to the process workflow. This may involve provisioning new resources, modifying existing configurations, or coordinating complex multi-step processes across multiple resources.

Additionally, the management worker 314 may forward host console data from the provider-specific computing resources 104 to a user device 108. This may allow administrators or end-users to access remote console interfaces for troubleshooting, monitoring, management purposes, or the like. Depending on network conditions and geographical proximity, the management worker 314 may relay host console data directly to the user device 108, bypassing the central management platform 106, potentially providing lower-latency access to the console when the user device 108 is geographically closer to the management worker 314 than to the central management platform 106. This approach may optimize console access performance, especially in geographically dispersed environments.

The distributed worker architecture utilizing the management worker 314 may enable efficient management of heterogeneous computing resources 104 across diverse cloud environments. By aggregating communications from the management platform 106 to a computing resource 104 through a multiplexed message stream, the management worker 314 may reduce network overhead and improve system performance, especially in geographically distributed scenarios. The flexible plugin system and ability to execute provider-specific operations locally may allow the management worker 314 to adapt to various cloud environments. This architecture may provide organizations with a scalable, adaptable solution for managing complex multi-cloud and hybrid cloud environments.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
establishing, by a management worker, a persistent connection between the management worker and a central management platform, the central management platform being deployed in a first network;
receiving, by the management worker, connection requests from agents of provider-specific computing resources, the provider-specific computing resources being deployed in a second network, the second network being different than the first network;
establishing, by the management worker, a multiplexed message stream in response to the connection requests, the multiplexed message stream being established using the persistent connection; and
relaying, by the management worker, messages between the agents and the central management platform through the multiplexed message stream.

2. The method of claim 1, wherein the messages comprise status updates from the agents to the central management platform, commands from the central management platform to the agents, or responses to the commands from the agents.

3. The method of claim 1, wherein the persistent connection is a WebSocket egressing from the management worker to the central management platform, and the multiplexed message stream is established using the Streaming Text Oriented Messaging Protocol over the WebSocket.

4. The method of claim 1, further comprising:
performing, by the management worker, error correction by storing a message history and resending unacknowledged messages from the message history after disruption of the persistent connection.

5. The method of claim 1, further comprising:
performing, by the management worker, data deduplication for the messages before relaying the messages.

6. The method of claim 1, wherein relaying the messages comprises:
receiving, by the management worker, a plugin from the central management platform, the plugin comprising plugin code;
forwarding, by the management worker, request messages from the central management platform to the agents by executing the plugin code; and
forwarding, by the management worker, response messages from the agents to the central management platform through the multiplexed message stream.

7. The method of claim 1, wherein relaying the messages comprises:
forwarding, by the management worker, request messages from the central management platform to the agents using provider-specific libraries of the agents; and
forwarding, by the management worker, response messages from the agents to the central management platform through the multiplexed message stream.

8. The method of claim 1, further comprising:
receiving, by the management worker, an orchestration sequence from the central management platform, the orchestration sequence comprising a process workflow for the provider-specific computing resources called for by a service request; and
executing the orchestration sequence by configuring the provider-specific computing resources according to the process workflow.

9. The method of claim 1, further comprising:
forwarding, by the management worker, host console data from the provider-specific computing resources to a user device.

10. A computer system comprising:
a central management platform deployed in a first network;
a plurality of provider-specific computing resources deployed in a second network, the second network being different than the first network; and
a management worker configured to:
establish a persistent connection between the management worker and the central management platform;
receive connection requests from agents of the provider-specific computing resources;
establish a multiplexed message stream in response to the connection requests, the multiplexed message stream being established using the persistent connection; and
relay messages between the agents and the central management platform through the multiplexed message stream.

11. The computer system of claim 10, wherein the messages comprise status updates from the agents to the central management platform, commands from the central management platform to the agents, or responses to the commands from the agents.

12. The computer system of claim 10, wherein the persistent connection is a WebSocket egressing from the management worker to the central management platform, and the multiplexed message stream is established using the Streaming Text Oriented Messaging Protocol over the WebSocket.

13. The computer system of claim 10, wherein the management worker is further configured to:
perform error correction by storing a message history and resending unacknowledged messages from the message history after disruption of the persistent connection.

14. The computer system of claim 10, wherein the management worker is further configured to:
perform data deduplication for the messages before relaying the messages.

15. The computer system of claim 10, wherein the management worker is configured to relay the messages by:
receiving a plugin from the central management platform, the plugin comprising plugin code;
forwarding request messages from the central management platform to the agents by executing the plugin code; and
forwarding response messages from the agents to the central management platform through the multiplexed message stream.

16. The computer system of claim 10, wherein the management worker is configured to relay the messages by:
forwarding request messages from the central management platform to the agents using provider-specific libraries of the agents; and
forwarding response messages from the agents to the central management platform through the multiplexed message stream.

17. The computer system of claim 10, wherein the management worker is further configured to:
receive an orchestration sequence from the central management platform, the orchestration sequence comprising a process workflow for the provider-specific computing resources called for by a service request; and
execute the orchestration sequence by configuring the provider-specific computing resources according to the process workflow.

18. The computer system of claim 10, further comprising:
a user device,
wherein the management worker is further configured to forward host console data from the provider-specific computing resources to the user device.

19. A computer device comprising:
a processor; and
a non-transitory computer-readable medium storing instructions which, when executed by the processor, cause the processor to:
establish a persistent connection between a management worker and a central management platform, the central management platform being deployed in a first network;
receive connection requests from agents of provider-specific computing resources, the provider-specific computing resources being deployed in a second network, the second network being different than the first network;
establish a multiplexed message stream in response to the connection requests, the multiplexed message stream being established using the persistent connection; and
relay messages between the agents and the central management platform through the multiplexed message stream.

20. The computer device of claim 19, wherein the persistent connection is a WebSocket egressing from the management worker to the central management platform, and the multiplexed message stream is established using the Streaming Text Oriented Messaging Protocol over the WebSocket.
